(19) United States
(12) Patent Application Publication
(10) Pub. No.: US 2024/0245977 A1
(43) Pub. Date: Jul. 25, 2024

(54) IMPACT CUSHIONING MATERIAL FOR PADDED GLOVES USED IN CONTACT SPORTS

(71) Applicant: Hayabusa Fightwear Inc., Kingston (CA)

(72) Inventors: Ken CLEMENT, Kingston (CA); David ZIKAKIS, Kingston (CA); Zakaria ADREF, Kingston (CA); Craig CLEMENT, Kingston (CA)

(21) Appl. No.: 18/564,436

(22) PCT Filed: Apr. 1, 2022
(86) PCT No.: PCT/CA2022/050505

§ 371 Date: Nov. 27, 2023

Related U.S. Application Data
(60) Provisional application No. 63/193,937, filed on May 27, 2021.

(51) Int. Cl. A63B 71/14; A41D 19/015

(52) U.S. Cl. CPC A63B 71/145; A41D 19/01523

(57) ABSTRACT

An impact cushioning material is provided for use in padded gloves for combat sports. The impact cushioning material comprises a first lattice and second lattice, each lattice configurable in structure to provide desired protection properties. The impact cushioning material allows for variable protection properties at different regions of the padded glove. The impact cushioning material can be used to provide all or the majority of the protection material within the glove, or in conjunction with other protective materials such as conventional foams. The impact cushioning material can also be configured as an insert, allowing for replacement and tailoring of use to a wider variety of conditions. The impact cushioning material can be manufactured from an elastomeric resin using conventional 3D printing properties, allowing for the varying properties of the material in a single component.

### FIELD OF INVENTION

The present invention relates to impact cushioning material for padded gloves: more specifically lattice structures for use in padded gloves for contact sports.

### BACKGROUND OF THE INVENTION

Many contact or combat sports, such as boxing or mixed martial arts, involve opponents striking one another with punches. As a result, fighters wear padded gloves to protect both themselves and their opponent. These padded gloves are worn on the fighter's hands for both matches and practices. The most common forms of padded gloves used in contact or combat sports are boxing gloves and grappling gloves.

Padded gloves are typically cushioned using a plurality of foam materials or injected molding. In cases where foam materials are used, the padded glove is often lined with several pieces of foam that may cover the fingers, knuckle, palm, dorsum, wrist and/or thumb portions of the hand. More than one piece of foam may be used to prevent deformation or aggregation in one part of the glove after repeated use. However, when foam pieces are too large they may ‘bunch up’ against the inner surfaces of the gloves, prematurely compressing the foam and potentially increasing the chance for injury of both the user and the sparring partner.

Injection molding may also be used to provide padding for the glove. In injection molding, an anatomical mold of a first or hand is made, and liquid foam is injected into the mold. The liquid injection is allowed to cool or cure until solid, foam padding is created. Unfortunately, this process is often time consuming and the shape/contours of the foam insert are limited to the shape/contours of the glove or mold. Foam padding, whether injected or otherwise, also suffer from degradation after repeated use. The foam inserts break down and the entire glove is often replaced. For heavy users, gloves may need to be replaced every few months.

Injection molding and foam layering methods also result in a less precise ability to design absorption and dampening characteristics of the glove in relation to specific portions or coverage of the hand. There is a need in the art for more precise design of absorption and dampening characteristics for impact protection material to be used in padded gloves for combat sports.

### SUMMARY OF THE INVENTION

The present invention relates to impact cushioning material for use in padded gloves for combat sports. The impact cushioning material provides for the tailored design and control of the absorption and dampening characteristics of the padded glove at specific portions of the hand.

In one embodiment of the present invention there is provided an impact cushioning material comprising a first lattice comprising a first plurality of cells formed by a first plurality of cell struts, the first plurality of cells defining a first mean cell volume, the first lattice having:
a. a finger portion at a first end, a dorsum portion at a second end, and a knuckle portion between the finger portion and the dorsum portion, and
b. a top side and a bottom side spanning between the first end and the second end:
   a second lattice located at the bottom side of the first lattice, the second lattice comprising a second plurality of cells formed by a second plurality of cell struts, the second plurality of cells defining a second mean cell volume; and the first mean cell volume is greater than the second mean cell volume.

In another embodiment of the invention, the impact cushioning material comprises cells having a ratio of first mean cell volume to second mean cell volume of about 1.4-1.45.

In a further embodiment of the invention, the impact cushioning material comprises a first lattice, integrally connected to a second lattice, with the impact cushioning material being manufactured using 3D printing technology from an elastomeric resin.

In a further embodiment of the invention, the impact cushioning material comprises a first lattice and second lattice having cells made up in a voronoi architecture.

In a further embodiment of the invention, the impact cushioning material is configured as an insert for use in a boxing glove.

This summary of the invention does not necessarily describe all features of the invention. Further embodiments and uses of the invention will be clear from the description provided.

### BRIEF DESCRIPTION OF THE DRAWINGS

These and other features of the invention will become more apparent from the following description in which reference is made to the appended drawings wherein:

FIG. 1 is an isometric view of an insert for a boxing glove:

FIG. 1A is a cross section taken along the (A) line in FIG. 1:

FIG. 1B is a close-up of the lattice structure of the insert

FIG. 2 is an isometric side view of the insert of FIG. 1:

FIG. 3 is an isometric top view of the insert of FIG. 1;

FIG. 3A is an isometric bottom view of the insert of FIG. 1:

FIGS. 4A and 4B are graphs showing impact analysis of boxing gloves with the insert of FIG. 1 (FIG. 4A) and conventional foam inserts (FIG. 4B);

FIG. 5 is a pictorial depiction of different embodiments of the invention:

FIG. 6 is a depiction of an insert for a boxing glove made up of a 3D-printed voronoi pattern, where the first lattice and second lattice are integrally connected:

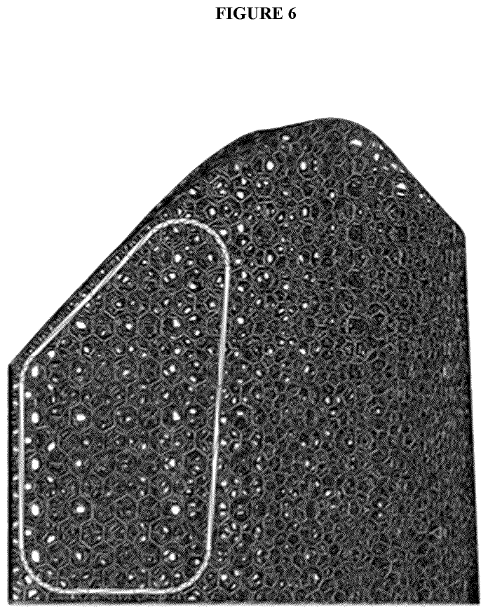

FIG. 7 is an isometric bottom view of the 3D-printed lattice of FIG. 6; and

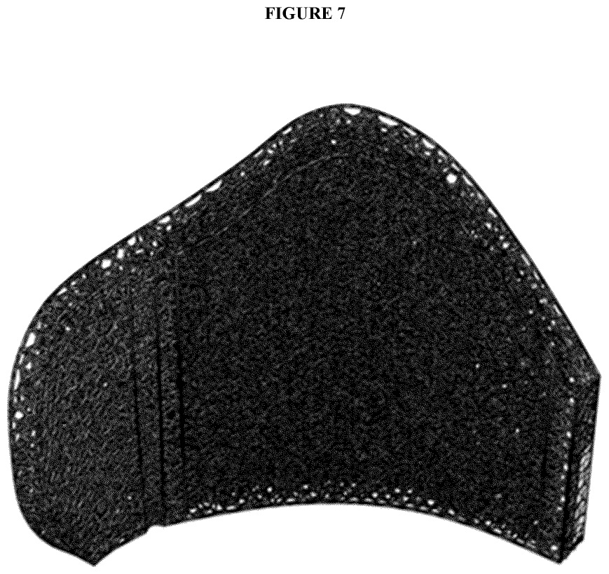

FIG. 8 is an isometric side view of the 3D-printed lattice of FIG. 6, displaying the differing voronoi cell sizes between the first lattice and second lattice.

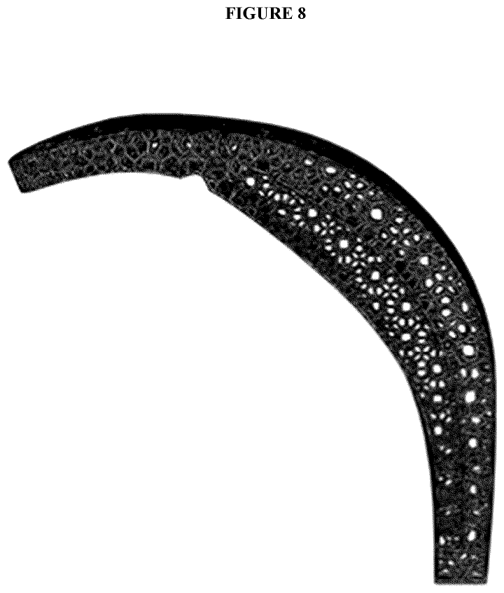

### DETAILED DESCRIPTION OF THE INVENTION

One or more illustrative embodiments have been described by way of example. Described herein are novel impact cushioning materials for padded gloves used in contact sports. It will be appreciated that embodiments and examples are provided for illustrative purposes intended for those skilled in the art, and are not meant to be limiting the invention in any way. All references to embodiments, examples, aspects, kits and the like is intended to be illustrative and non-limiting.

The illustrated embodiments of impact cushioning materials described herein are disclosed in detail as inserts, being manufactured as separate components and otherwise inserted into the body of a boxing glove to act as impact cushioning material. However, the invention equally encompasses the impact cushioning material in an integrally connected form of the glove, rather than being “inserted” within a separate body or component of a padded glove. In either instance, the overall beneficial properties of the impact cushioning material remain constant and benefit from use of the invention.

Dimensions of the inserts are generally described in relation to the shape and position of the hand. For example, the inserts are described as having portions generally aligning with the relative regions of the wearer's hand. In addition, the following terms are used throughout to refer to the following general parameters:
a. “height” refers to the measurement across the breadth of the hand, from the index finger to the small or “pinky” finger;
b. “length” refers to the measurement from the wrist extending towards the tip of the fingers; and
c. “thickness” refers to a distance towards or away from the top or bottom surface of the hand.

These dimensions are only intended to generally describe orientations and relative positions in describing the inserts, and are not intended as fixed or set dimensions for the insert. No limitation is intended regarding direction, position, or extent of coverage by any of these terms, and a given dimension may start from either indicated position (or somewhere internal to an indicated position). For example, the height of the insert may not fully extend from the index finger to the pinky finger, but may only cover some of the height of the hand not including the index and/or little finger.

The insert exemplified and described in detail herein is an insert for a right-handed boxing glove. The same design properties apply to an insert for a left-handed glove. Due to the similarity in design only an insert for a right-hand glove is discussed in detail.

### Properties of the Insert

Described herein is an impact cushioning material configured as an insert 10 for a boxing glove. This insert 10 comprises a first lattice 12 and a second lattice 14. The insert 10 is inserted into a cavity of a boxing glove to replace and/or supplement traditional cushioning components such as foams. Alternatively, the first lattice 12 and second lattice 14 are manufactured within the glove to provide a single unit of impact cushioning material, rather than as a separate insert. First lattice 12 and second lattice 14 may be separate pieces, or may be a single piece differentiated by their differing lattice properties.

The insert 10 may cover one or more of fingers, knuckle, dorsum or opisthenar area or part of a user's hand, or any combination thereof. In some cases, insert 10 is the only substantive protective cushioning within the boxing glove. The insert 10 may provide a cushion and protection to the user's hand while also being rigid and/or resilient enough to retain its shape after prolonged use.

Different properties for the first lattice 12 and second lattice 14 allow for control of the properties of the insert. These different properties of the first lattice 12 and second lattice 14 are obtainable by varying the structure and/or composition of each respective lattice. In an illustrated embodiment, second lattice 14 may be less rigid or resilient than first lattice 12, and second lattice 14 may also compress more easily to absorb more incoming force than first lattice 12. For example, first lattice 12 may be up to 200% more rigid than second lattice 14. In some embodiments, the first lattice 12 is 30% more rigid. One possible benefit of the second lattice 14 having a lower rigidity or resiliency than the first lattice 12 is that the second lattice 14 may have a softer feel around a user's knuckles in use, increasing comfort for the wearer while still maintaining an overall desired degree of protection. The overall protection for the glove is maintained through the use of a more rigid first lattice 12.

The term “lattice” will be understood as a three-dimensional structure comprised of an arrangement or pattern of smaller (often repeating) structures, such as cells. In some embodiments, the cells may have cell walls that act to enclose the space within a cell, either partially or completely. In a preferred embodiment, the cell “walls” resemble struts or posts, which otherwise allow the faces of each cell to be open to one another throughout the lattice. For simplicity, both will be described herein as cell “struts”, despite these potential differences in structure. Where properties of the cell strust are discussed, these properties are equally applicable to cell walls. For example, the cell strut “width” is equivalent to the thickness of the cell wall, not the span across the face of the cell (which would be absent for struts).

The lattice may be composed of a series of repeating, identical structures or a combination of non-identical structures. In some cases, the lattice is composed of at least one series of repeating structures in one portion, and at least one series of irregular structures another portion. In another embodiment, the lattice is made up of alternating repeating structures, making up different “sub-units” within the lattice. The characteristics of these lattices are configurable to obtain the desired properties of the insert, such as rigidity, flexibility, comfort, and longevity. Where the various cells of the lattice are open to one another, an added benefit of the lattice structure is increased airflow throughout the whole of the structure.

The lattice may be described as having an architecture or more than one architectures. The term “architecture” will be understood as a local or overall organization of substructures within a lattice. For example, the substructures (such as one or more cells) may have an organizational structure of a voronoi pattern, gyroid pattern, or flat radial pattern (FRP). Other architectures known in the art may be used, such as a grid, concentric, triangular, rectangular, rectilinear, honeycomb, cubic, or combinations thereof. In some embodiments, the first lattice and/or second lattice comprises a voronoi, gyroid, or FRP architecture. In a preferred embodiment, the architectures of the first lattice and second lattice are made up of the voronoi pattern. Mixtures of varying architectures within a lattice, and/or differing between the first lattice and second lattice, may also be used.

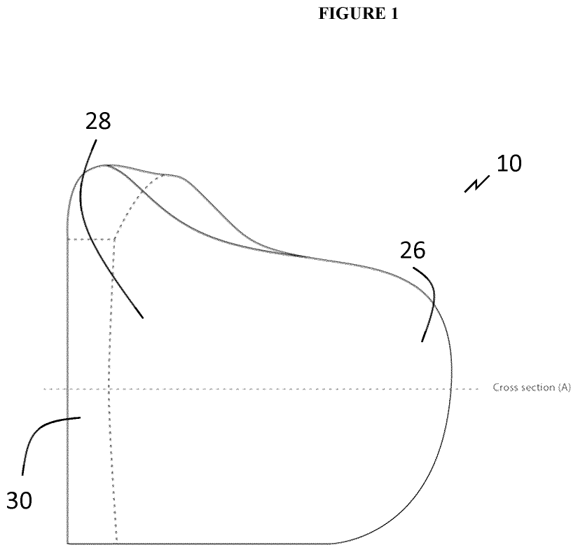

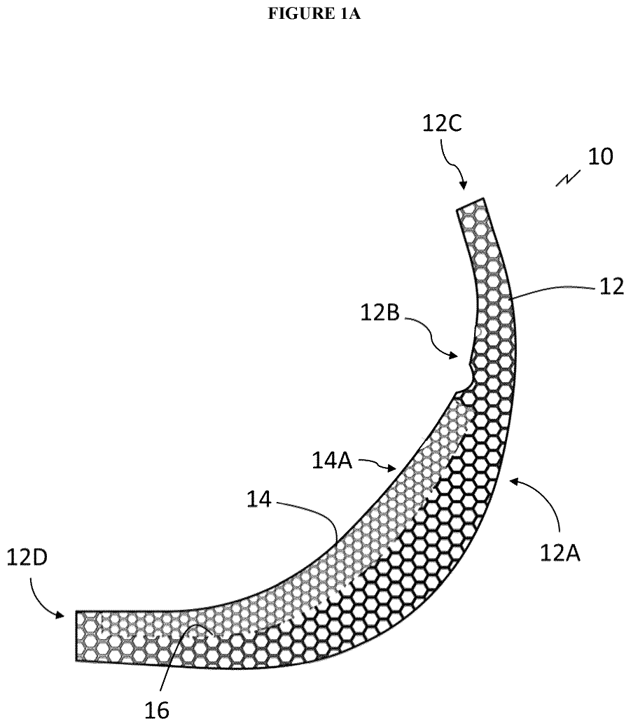

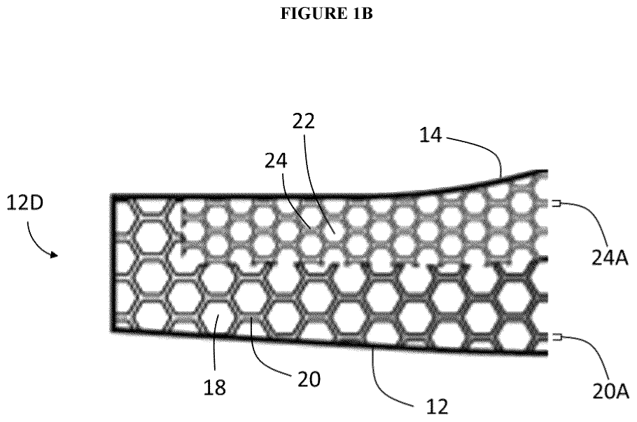

Referring to FIG. 1, the illustrated embodiment shows the protection material configured for use as an insert 10 for a boxing glove. The insert 10 is shaped to provide cushioning for the majority of the wearer's hand, excluding the thumb. The insert 10 generally comprises a finger portion 26 located over a portion of the fingers of the wearer's hand, a knuckle portion 28 located generally over the knuckles of the wearer's hand, and a dorsum portion 30 located over a portion of the dorsum of the wearer's hand (extending back into the page).

FIG. 1A shows a cross-sectional view of the insert 10 in the illustrated embodiment of FIG. 1, taken along line A. FIG. 1A also highlights the unique properties of the impact cushioning material, including the first lattice 12 and second lattice 14. First lattice 12 covers the finger portion 26, knuckle portion 28, and dorsum portion 30. Second lattice 14 covers a smaller area of the wearer's hand, comprising a knuckle portion 28 and dorsum portion 30. However, the specific coverage of the first lattice 12 and second lattice 14 can be varied according to the desired protection of the overall insert 10. For example, different insert designs may be provided to allow for different protection properties of competition gloves, sparring gloves, or training gloves. Alternatively, in contrast to boxing gloves, the insert for grappling gloves may have a smaller dorsum portion 30 and/or finger portion 26, or may omit one the dorsum portion 30 and/or finger portion 26 entirely.

In the illustrated embodiment, the first lattice 12 extends from a first end 12C located within the finger portion 26, to a second end 12D located within the dorsum portion 30. The finger portion 26 is fitted to protect portions of a user's fingers within the boxing glove in use. Dorsum portion 30 is sized to protect a portion of the back, or dorsum, of a user's hand in use. Knuckle portion 28 is located between finger portion 26 and dorsum portion 30 and protects portions of a user's knuckles in use. First lattice 12 also has a top side 12A that faces away from a user's hand and a bottom side 12B that faces towards a user's hand in use.

In the illustrated embodiment, the first lattice is composed of a single piece having a finger portion 26, knuckle portion 28, and dorsum portion 30. However, the invention equally contemplates a first lattice made up of multiple separate pieces that are joined, adhered, or otherwise connected together (directly or indirectly) to provide the desired impact cushioning properties. The same is true of the second lattice 14.

Referring to FIG. 1A, second lattice 14 is nested within first lattice 12. The term “nested” will be understood as second lattice 14 being shaped to fit into an opening in the first lattice 12 at an interface 16. In some cases, second lattice 14 is nested within the first lattice 12 such that a generally continuous surface is formed from the bottom side 12B of first lattice 12 to the bottom side 14A of second lattice 14. Second lattice 14 may be nested in at least part of the knuckle portion 28. In some cases, lattice 14 extends from the knuckle portion 28 to the dorsum portion 30 and/or the finger portion 26. Second lattice 14 need not be nested within first lattice 12, and in an alternative embodiment second lattice 14 is located at the bottom side of first lattice 12.

In one embodiment, the first lattice 12 and second lattice 14 are manufactured as separate pieces, and the second lattice 14 is adhered to first lattice 12 at the interface 16 via a suitable method, such as heat lamination, chemical adhesives, fasteners or other methods known in the art. In a preferred embodiment, second lattice 14 may be integrally formed with first lattice 12 during manufacturing, providing the dual-properties of two lattices within a single piece. Where the first lattice 12 and second lattice 14 are a single piece, the interface 16 is defined by the change in characteristics of the lattice.

Referring to FIG. 1B, first lattice 12 comprises a first plurality of cells 18 formed by a first plurality of struts 20. This first plurality of cells 18 has a first cell strut width 20A. Second lattice 14 comprises a second plurality of cells 22 formed by a second plurality of struts 24. The second plurality of cells has a second cell strut width 24A. The width of the first and second plurality of struts may be varied between first lattice 12 and second lattice 14. The strut width may also vary within a given lattice. For example, the first strut width 20A within the knuckle portion 28 of the first lattice 12 may be greater than the strut width of the first plurality of struts within the finger portion 26 of the first lattice 12 (not shown).

First cell strut width 20A and second cell strut width 24A can range from 0.1-5 mm. In a preferred embodiment, first cell strut width 20A ranges from 1-5 mm and second cell strut width 24A ranges from 0.1-2 mm. In a more preferred embodiment, first cell strut width 20A ranges from 1-2 mm and second cell strut width 24A ranges from 0.5-1.5 mm. In the most preferred embodiment, first cell strut width 20A is approximately 1.3 mm and second cell strut width 24A is approximately 0.8 mm.

The characteristics of the lattice may be specifically configured through the selected sizing of cell struts. For example, increasing the width of the first or second plurality of struts may increase the rigidity of the cells. The specifics of the strut width may also impact the feel of the lattice. For example, the second lattice 14 shown in FIG. 1B may have a softer feel on the knuckles when in use, compared to the first lattice 12, due to the smaller second cell strut width 24A compared to first cell strut width 20A.

Each of the first plurality of cells 18 or second plurality of cells 22 may have a suitable cell shape, formed by the first plurality of struts 20 or second plurality of struts 24, respectively. For example, as shown in FIGS. 1A and 1B, the struts and cells may define a hexagonal or honeycomb arrangement in cross-section. In other cases, the struts may define cells with other suitable shapes known in the art, such as square, triangular or others. The cells may also have an irregular shape, and in a preferred embodiment the cells of the first lattice 12 and second lattice 14 are found in a voronoi pattern.

First plurality of cells 18 and second plurality of cells 22 define a first mean cell volume and a second mean cell volume, respectively. It will be understood that a “mean cell volume” refers to an average value of cell volumes calculated over a specific area. For example, the first mean cell volume of the first lattice is the average cell volume of the cells within the entirety of the first lattice 12. As another example, a mean finger cell volume of the first lattice is the average cell volume of the cells within the finger portion 26 of first lattice 12. Mean cell volume may also be calculated for portions of the insert overall, including both the first lattice 12 and second lattice 14, such as where a mean knuckle cell volume of the insert 10 is calculated by averaging the mean volume of both the knuckle portion 28 of first lattice 12 and knuckle portion 28 of the second lattice 14.

In some cases, a “mean cell count” is used to define the properties of a lattice. In such cases, a cell count is a simple count of cells within a specified area or volume. For example, a first lattice mean cell count is the mean number of cells/cm³ of the first lattice 12. Portions of a lattice may equally be characterized in this manner, for example the first lattice knuckle portion mean cell count may be defined using the mean number of cells/cm³ in the knuckle portion 28 of the first lattice 12.

Mean cell volume and mean cell count can also be relative measurements as between the first lattice 12 and second lattice 14, or respective portions of a given lattice. For example, characteristics of the first lattice 12 and second lattice 14 may be expressed as a ratio between the knuckle portion 28 of the first lattice 12 and the knuckle portion 28 of the second lattice 14.

First plurality of cells 18 and second plurality of cells 22 can alternatively be defined by their approximate cell size, by measuring their respective dimensions (for example, by measuring strut lengths, widths, and heights). This may also allow for calculation of cell volume. For example, where hexagonal cells are present the volume can be calculated using cell size, based upon the length and height of the struts that define the cell.

In some embodiments the cell size of the first plurality of cells 18 have strut lengths ranging from 1-50 mm, preferably 5-25 mm, and more preferably 10-15 mm, and in the most preferred embodiment approximately 11-14 mm. The second plurality of cells 22 have strut lengths ranging from 1-50 mm, preferably 1-15 mm, more preferably 6-10 mm, and in the most preferred embodiment approximately 7.5 mm.

Referring to the illustrated embodiment of FIG. 1B, the mean cell volume of the first lattice 12 is greater than the mean cell volume of the second lattice 14. In some cases, a ratio of the mean cell volume of the first lattice 12 to the mean cell volume of the second lattice 14 is about 1.01-2. For example, a range of about 1.01-20 or any value therebetween (optionally rounded to the nearest 0.1), or any subrange spanning between any two of these values, such as about 1.4-1.45 may be suitable. For example, ratios of 1.01, 1.015, 1.02, 1.025, 1.03, 1.036, 1.04, 1.045, 1.05, 1.055, 1.06, 1.065, 1.07, 1.075, 1.08, 1.085, 1.09, 1.095, 1.1, 1.11, 1.12, 1.13, 1.14, 1.15, 1.16, 1.17, 1.18, 1.19, 1.2, 1.21, 1.22, 1.23, 1.24, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 5, 6, 7, 8, 9, 10, 11, 12, 13, 14, 15, 16, 17, 18, 19, 20 and others are considered.

Referring to FIG. 1B, the first strut width 20A may be greater than the second strut width 24A. In some cases, a ratio of the first strut width 20A to the second strut width 24A is about 1.01-3. For example, a range of 1.01-20 or any value therebetween (optionally rounded to the nearest 0.1), or any subrange spanning between any two of these values, such as about 1.5-1.55 may be suitable. For example, ratios of 1.01, 1.015, 1.02, 1.025, 1.03, 1.036, 1.04, 1.045, 1.05, 1.055, 1.06, 1.065, 1.07, 1.075, 1.08, 1.085, 1.09, 1.095, 1.1, 1.11, 1.12, 1.13, 1.14, 1.15, 1.16, 1.17, 1.18, 1.19, 1.2, 1.21, 1.22, 1.23, 1.24, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 5, 6, 7, 8, 9, 10, 11, 12, 13, 14, 15, 16, 17, 18, 19, 20 and others are considered. In the most preferred embodiment, the ratio of first strut width 20A to second strut width 24A is 1.625.

The mean cell volume may vary within parts of the insert 10, such as within the first lattice 12. For example, each of finger portion 26, knuckle portion 28 and dorsum portion 30 of the first lattice 12 may define a respective mean cell volume (ie. mean finger cell volume, mean knuckle cell volume, and mean dorsum cell volume). The mean cell volume of each portion of the first lattice 12 may differ from one another (not shown). For example, the mean knuckle cell volume may be less than the mean finger cell volume and/or the mean dorsum cell volume. In such embodiments, a lesser knuckle cell volume results in relatively smaller cells around knuckle portion 28, which may provide increased protection of the wearer's knuckles relative to the fingers and dorsum. The same variation in defined mean cell volume within differing portions of the second lattice 14 may also be present.

Generally, lower cell volume results in a higher cell count within a given area. Increasing the cell count can have various effects, such as increasing the weight and/or rigidity of the insert 10. Similarly, increasing the cell volume may reduce the cell count in a given area, decreasing the relative weight and/or rigidity of the insert 10. By varying the cell volume and strut thickness in differing portions of the first lattice 12 and second lattice 14, the desired properties of the insert 10 can be obtained.

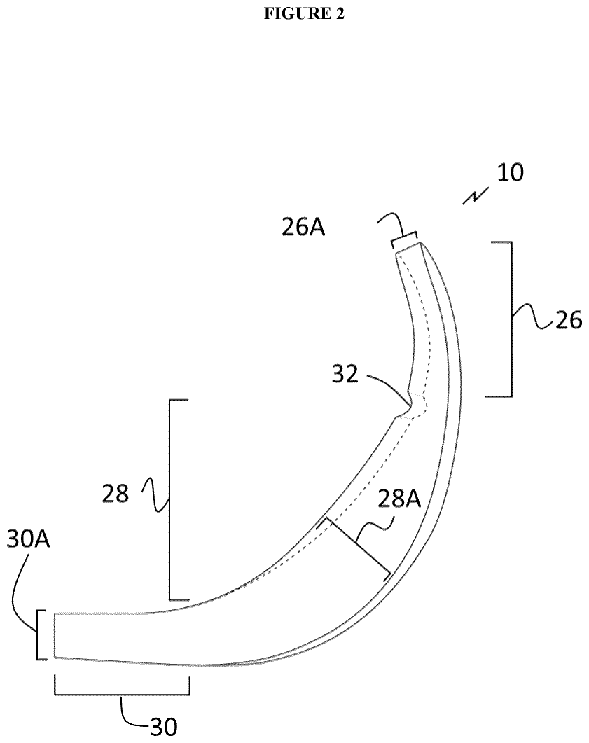

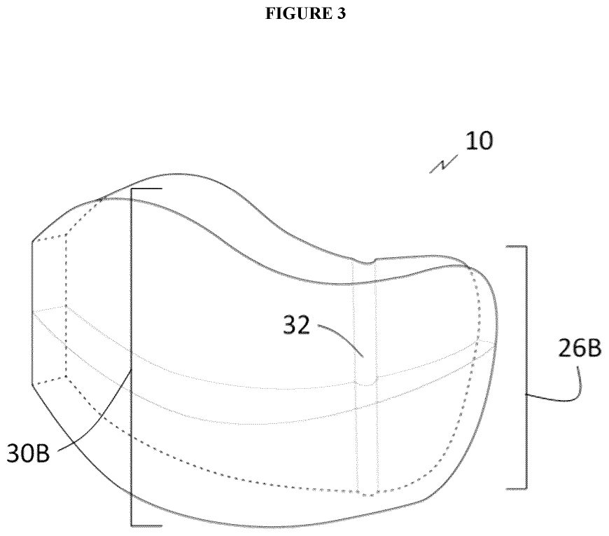

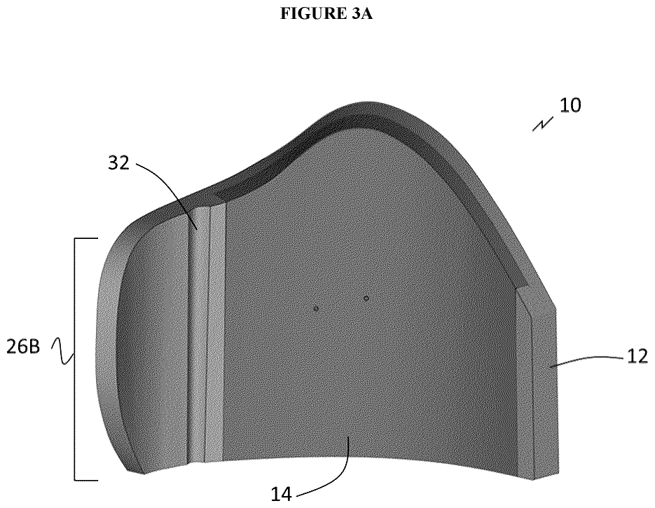

Referring to FIGS. 2, 3, and 3A, first lattice 12 may contain a recess 32 spanning the width of the insert 12E. Recess 32 is located approximately between finger portion 26 and knuckle portion 28. Recess 32 may provide a bending axis, allowing insert 10 to bend with a user's fingers in use. As an illustrative example, recess 32 allows bending of insert 10 when the user makes a fist. Recess 32 may act to decrease bending stress in the knuckle and finger portions 26, 28. Recess 32 may also allow for ease of manufacturing, to allow insert 10 to be readily placed within a boxing glove.

In some cases, recess 32 is a plurality of recesses spaced from one another (not pictured) instead of a single recess spanning the full width 12E. The plurality of recesses may be spaced such that bending stress is decreased when insert 10 is bent. Depending upon the size of the insert, multiple recess 32 may be used. Recess 32 may allow for proper creasing in use, and decreasing the load on the geometry of the lattice if it were folding on itself. This may prevent premature break points. Multiple recesses 32, or series of recesses 32, may also be present.

Referring to FIGS. 1A, 3, and 3A, insert 10 may define a profile with an arcuate shape along its length, from first end 12C to second end 12D, providing for a curved design to the insert 10. The arcuate profile may be curved to enhance the fit around a user's hand in use. The arcuate profile may be curved such that a length of a top curved plane of the insert is greater than a length of a bottom curved plane of the insert. In some embodiments, top side 12A is longer than bottom side 12B.

A curved design may allow the insert 10 to more readily contour to the curvature of the hand when forming a proper first position for punching. Such contouring may allow for greater glove ergonomics by limiting the amount of movement required to manipulate the insert into the desired position. The specific curve may also be varied according to the size and/or weight of the insert 10. The curved design, measured along the bottom side 12B of the first lattice 12 from the first end 12C to second end 12D, may range from 0 to 180 degrees, more preferably from 90-180 degrees. In the preferred embodiment, the curve is approximately 120 degrees.

Referring to FIGS. 2, 3, and 3A, both the height and thickness of the insert may vary between the dorsum, knuckle and finger portions. For example, a thickness of the finger portion 26A may be less than a thickness of the knuckle portion 28A and/or thickness of the dorsum portion 30A. In some embodiments, thickness of the knuckle portion 28A is greater than thickness of the finger portion 26A and/or dorsum portion 30A. As a further example, the width of the insert 10 at the finger portion 26B may be smaller than the width of the insert of the dorsum portion 30B. Increasing a thickness and/or height of one or more portions results may impact the coverage of the wearer's hand and increased material in said portion, which may result in increased rigidity and/or weight. The tailoring of height and thickness may allow for further specific impact cushioning properties of the insert 10.

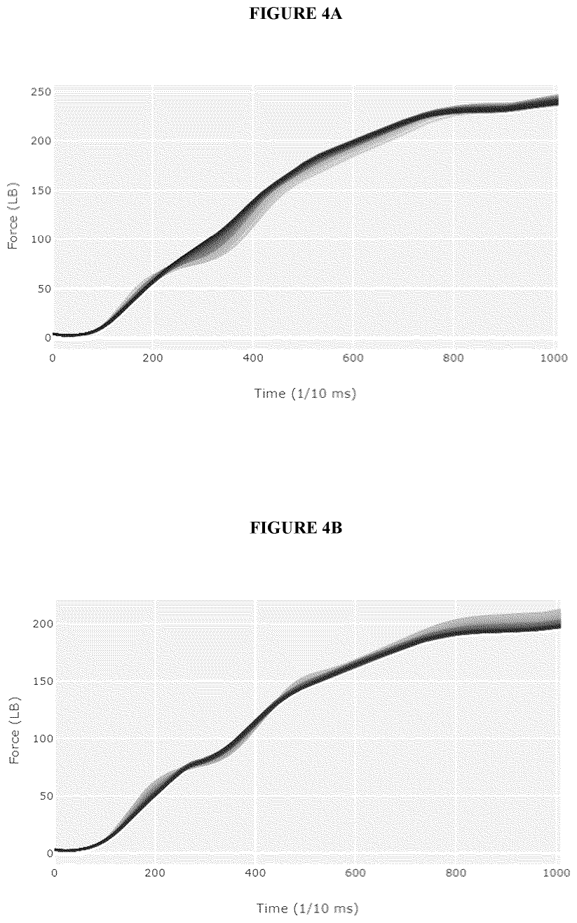

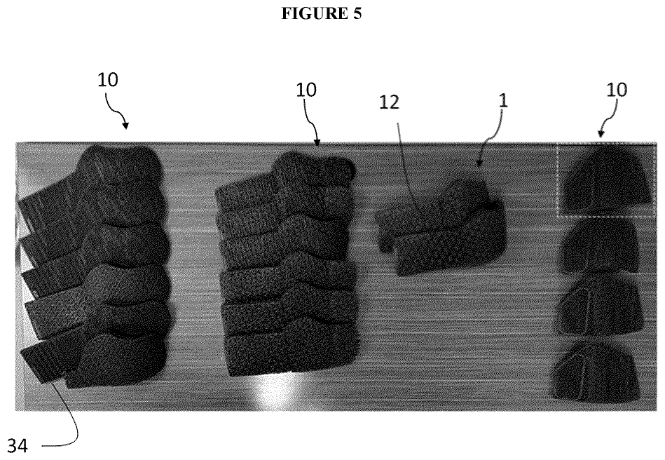

Referring to FIG. 4, insert 10 may further comprise additional portions. For example, insert 10 may further comprise a wrist portion 34 extending from dorsum portion 30. Wrist portion 34 may cover and protect a user's wrist in use. Wrist portion 30 may be integrally formed, as shown in FIG. 5, or be adhered to insert 10. For example, wrist portion 34 may be chemically adhered to second end 12D. Optional wrist portion 34 may be made of a similar material as insert 10, or an alternative material such as foam. In some embodiments, insert 10 further comprises a thumb portion (not shown). The thumb portion may extend from the dorsum portion 30 such that a user's thumb is covered and/or protected in use. Thumb portion may be integrally formed, or adhered to insert 10, using the same or different materials than the remainder of the insert 10.

### Method of Manufacturing Inserts

Insert 10 may be composed of a suitable material to absorb impact energy, while being resilient and return to their initial configuration to allow for repeated use. In one embodiment, first lattice 12 and second lattice 14 may be composed of a printable plastic or resin suitable for use in 3D printing. The resin may be a relatively rigid resin that allows for limited bend and flexibility. In some cases, the resin may be cured by a suitable process, such as UV curing. Many resins known in the art may be used, such as those found in Lee, J-Y et al. “Fundamentals and applications of 3D printing for novel materials.” Appl. Mat. Today, 2017, 7, pp. 120-33, and Shahrubudin, N. et al. “An Overview on 3D Printing Technology: Technological, Materials, and Applications.” Procedia Manufacturing, 2019, 35, pp. 1286-96, which are herein incorporated by reference in their entirety. The insert 10 can be manufactured using a variety of 3D printing technologies. For example. Insert 10 can be manufactured using stereolithography, selective laser sintering, polyjet, or digital light processing, multi jet fusion, or fused deposition modeling 3D printing technologies, depending upon the size of components and desired material or resin used.

In a preferred embodiment, the first lattice 12 and second lattice 14 are manufactured using stereolithography 3D printing technology (SLA). SLA allows for suitable control of the architecture of the first lattice 12 and second lattice 14. In a preferred embodiment, the insert 10 is 3D printed using SLA technology as a single unit, where first lattice 12 and second lattice 14 are integrally connected and the SLA process provides for customization of the different architecture of these two lattices within the single, integral unit.

Insert 10 can be printed using a variety of resins suitable to provide cushioning to impacts, after which they return to their original shape. In a preferred embodiment, the insert is made of an elastic, tear resistant resin in the form of an elastomer having high resiliency. In a further preferred embodiment, the elastomeric resin is an elastomeric polyurethane SLA resin.

Suitable resins may have one or more of the following tensile properties (measured using ASTM D412, Type 5 500 mm/min):
a. A Chord Modulus ranging from 5-15 MPa, more preferably from 10-14 MPa;
b. An Ultimate Tensile Strength ranging from 13-25 MPa, more preferably 18-22 MPa;
c. A Tensile Stress at 100% Elongation ranging from 3-6 MPa, more preferably 4-6 MPa; and d. An Elongation at Break ranging from 200-350%, more preferably 230-330%.

Parts of insert 10 may also be composed of a compressible foam. For example, in embodiments where a thumb portion is present, the thumb portion may be composed of a compressible foam rather than resin. The insert 10 may also be used with a boxing glove that is lined with foam, wherein the insert provides additional protection along with the protection provided by the foam. Insert 10 may also be used with boxing gloves that have one or more splints to provide further support. In some embodiments, first lattice 12 and/or second lattice 14 may be broken up into separate sub-units, connected by foam regions or other materials.

As an illustrative example, insert 10 is manufactured as a separate component, and assembled within a boxing glove during manufacturing. The glove outer shell may be a standard construction, with insert 10 placed within the body of the boxing glove during assembly. Depending on the size of the insert 10, elements of foam may be constructed within the glove such as thumb padding or added section on the dorsal surface towards the wrist area. In some cases, adhesives may be used to attach foam splinting that covers the back of the hand and over the wrist. When the boxing glove is worn, the insert 10 provides the desired cushioning for the wearer's hand, while maintaining optimal glove characteristics such as weight, durability, and comfort.

Insert 10 may be used in various sizes of boxing gloves. For example, the insert 10 may be used in an 18 or 20 ounce boxing glove. Insert 10 may be scaled to fit in larger or small gloves. The insert may be scaled down to fit in smaller sizes, such as 10, 12, 14 and 16 ounce sizes. Due to the beneficial properties of the insert 10, a boxing glove containing insert 10 may provide the equivalent degree of protection to conventional boxing gloves at a lower glove weight. For example, a 16 ounce glove containing insert 10 may be configured to provide equivalent protection to an 18 or 20 ounce glove using conventional foam padding.

Insert 10 may also be configured in such a manner that it can be readily removed from the boxing glove. This may provide the ability for a single pair of gloves to be fitted with different types of insert 10, having different properties of first lattice 12 and second lattice 14, thereby extending the functional use of the glove. For example, a single pair of boxing gloves can be used with one version of insert 10 for sparring, or a second version of insert 10 for training, each insert having different properties. The use of an exchangeable insert 10 in this manner would reduce the number of boxing gloves required by the fighter. Alternatively, if the insert 10 becomes damaged or worn with use, replacement of the insert 10 alone may provide cost savings compared to replacement of the whole boxing glove.

### Impact Testing of a Boxing Glove Containing an Insert

The insert 10 provides preferred properties over traditional foam padding for boxing gloves with respect to the cushioning of impacts. Referring to FIGS. 5A and 5B, two boxing gloves were subjected to impact testing, one being a boxing glove containing the described insert 10 (results shown in FIG. 5A) and the other being a convention boxing glove containing conventional foam (results shown in FIG. 5B). In each case, a boxing glove was secured to a cylindrical mandrel of a punching machine, and subjected to 240 sequential impacts. The mandrel used in the test contained sensors aligned approximately with the location of a fighter's knuckles.

FIG. 5A shows the results from a boxing glove having an insert 10 made of the described impact cushioning material. The tested insert 10 was manufactured using the elastomeric polyurethane SLA resin EPU 43, with first lattice 12 having a finger portion 26, knuckle portion 28, and dorsum portion 30. The second lattice 14 was integrally connected and nested within the first lattice 12 during manufacturing, having a knuckle portion 28 and dorsum portion 30. Cells of first lattice 12 were configured in a voroni pattern, and first cell strut width 20A of approximately 1.3 mm. Cells of second lattice 14 were also configured in a voroni pattern, having a second cell strut width 24A of approximately 0.8 mm. The insert 10 had a width sufficient to provide coverage of all four fingers of a hand.

FIG. 5B shows the results from a conventional boxing glove. The “conventional” boxing glove used contained polyethylene foams, latex foam, and polyurethane.

The pneumatic cylinder was charged for 500 ms for each impact. Impacts for each glove were measured as a function of impact force (in lbs, y-axis) over time (in 0.1 ms, x-axis). Measurements were taken at 0.1 ms intervals, for a total sampling time of 100 ms per impact. All 240 impacts of each glove are displayed on the same graph, with color intensifying as the impact number increased. For example, impact 240 appears as the darkest line in FIGS. 5A and 5B.

By displaying both the force over time for an individual impact, as well as the change in force at a given time across the 240 subsequent impacts, FIGS. 5A and 5B demonstrate both the individual impact cushioning response of the insert 10, as well as its durability.

Referring to FIG. 5B, which tested a standard boxing glove, a “stepped” profile can be seen (best observed when reviewing the darkest line plot), where the force does not uniformly increase over time. Instead, there are a series of phases or steps over time. This stepped profile in the impact data of the conventional foam insert is a result of the layered nature of the traditional laminated foam construction of the boxing glove, which typically employ multiple foam types. As the individual layers of differing foams are compressed, they provide a varying amount of resistance to the impact rather than acting as a single unit. This results in a non-linear response.

FIG. 5A shows the results of impacts with a boxing glove containing the described insert 10. FIG. 5A displays a smoother impact profile (best observed when reviewing the darkest line plot) without large steps or phases over time. This indicates that the described insert 10 provides a more consistent amount of resistance to the impact compared to conventional foam padding, as the 3D printed lattice is better able to act as a single unit with a consistent impact cushioning response.

All citations are hereby incorporated by reference. In the event of conflicting information with statements between any reference to or incorporated herein, and the present disclosure, the present disclosure will act as the guiding authority.

The present invention has been described with regard to one or more embodiments. However, it will be apparent to persons skilled in the art that a number of variations and modifications can be made without departing from the scope of the invention as defined in the claims.

1. Impact cushioning material for use in a boxing glove, said impact cushioning material comprising:
a first lattice comprising a first plurality of cells formed by a first plurality of cell struts, the first plurality of cells defining a first mean cell volume, the first lattice having:
a) a finger portion at a first end, a dorsum portion at a second end, and a knuckle portion between the finger portion and the dorsum portion, and
b) a top side and a bottom side spanning between the first end and the second end;
a second lattice located at the bottom side of the first lattice, the second lattice comprising a second plurality of cells formed by a second plurality of cell struts, the second plurality of cells defining a second mean cell volume;
wherein the first mean cell volume is greater than the second mean cell volume; and
wherein the first lattice and the second lattice are provided in the top side.

2. The impact cushioning material of claim 1, wherein the impact cushioning material defines an arcuate profile such that a length of a top side of the insert is greater than a length of a bottom side of the insert and/or wherein the arcuate profile of the bottom side is approximately 120 degrees, measured between the first end and the second end.

3. (canceled)

4. The impact cushioning material of claim 1, wherein the second lattice is nested within a portion of the first lattice.

5. The impact cushioning material of claim 1, wherein a ratio of the first mean cell volume to the second mean cell volume is about 1.01-2 or wherein the ratio is about 1.4-1.45.

6. (canceled)

7. The impact cushioning material of claim 1, wherein the finger portion defines a mean finger cell volume, the knuckle portion defines a mean knuckle cell volume, the dorsum portion defines a mean dorsum cell volume, and the mean knuckle cell volume is less than the mean finger cell volume and/or the mean dorsum cell volume.

8. The impact cushioning material of claim 1, wherein the first plurality of cell struts defines a first cell strut width, the second plurality of cell struts defines a second cell strut width, and the first cell strut width is greater than the second cell strut width.

9. The impact cushioning material of claim 8, wherein a ratio of the first cell strut width to the second cell strut with is about 1.01-3 or wherein the ratio is about 1.625.

10. (canceled)

11. The impact cushioning material of claim 1, wherein a thickness of the knuckle portion is greater than a thickness of the finger portion and/or a thickness of the dorsum portion.

12. The impact cushioning material of claim 1, wherein at least part of the first lattice comprises a voronoi, gyroid, or flat radial pattern (FRP) architecture.

13. The impact cushioning material of claim 12, wherein at least part of the first lattice comprises the voronoi architecture and/or wherein the knuckle portion of the first lattice comprises the voronoi architecture.

14. (canceled)

15. The impact cushioning material of claim 1, wherein at least part of the second lattice comprises a voronoi, gyroid, or flat radial pattern (FRP) architecture.

16. The impact cushioning material of claim 15, wherein at least part of the second lattice comprises the voronoi architecture.

17. The impact cushioning material of claim 1, wherein at least one cell of the first plurality of cells defines a triangular, rectangular, hexagonal, or irregular shape and/or at least one cell of the second plurality of cells defines a triangular, rectangular, hexagonal, or irregular shape.

18. (canceled)

19. The impact cushioning material of claim 1, wherein at least a portion of the insert comprises a 3D-printable resin.

20. The impact cushioning material of claim 19, wherein the 3D-printable resin is an elastomeric resin and/or wherein the 3D-printable elastomeric resin has a chord modulus of about 10-14 MPa.

21. (canceled)

22. The impact cushioning material of claim 1, further comprising a foam thumb portion adhered to the dorsum portion.

23. The impact cushioning material of claim 1, wherein the impact cushioning material is configured as one portion of the padding of the boxing glove and/or wherein the impact cushioning material makes up a majority of the protective material in the boxing glove.

24. (canceled)

25. The impact cushioning material of claim 1, wherein the impact cushioning material is configured as an insert for use in the boxing glove.

26. The insert of claim 25, wherein said insert can be replaceably removed from the boxing glove.

27. A boxing glove, comprising the impact cushioning material of claim 1.
